(19) United States
(12) Patent Application Publication
(10) Pub. No.: US 2012/0023444 A1
(43) Pub. Date: Jan. 26, 2012

(54) INTERNET TV CONTENT SHARING AND REVENUE GENERATION USING BUDDY LISTS AND SHORT MESSAGES

(75) Inventors: Abhishek P. Patil, San Diego, CA (US); Djung N. Nguyen, San Diego, CA (US); Xiangpeng Jing, Jersey City, NJ (US)

(73) Assignee: SONY CORPORATION

(21) Appl. No.: 12/839,529

(22) Filed: Jul. 20, 2010

(51) Int. Cl. G06F 15/16; G06F 3/048; G06F 21/00; H04L 9/32

(52) U.S. Cl. 715/810; 726/1; 709/217; 726/7

(57) ABSTRACT

A CE device such as an Internet protocol TV (IPTV), Internet-enabled digital radio, Internet-enabled game console. Instead of or in addition to device-centric authentication, user-centric authentication may be used with an Internet TV server which stores information on the preferences of each user and which also enables users to login to the Internet TV service from any enabled device. By means of the server the user can recommend Internet TV content to other system users on a buddy list, and should a buddy accept a user's recommendation and view recommended content the user is rewarded for each successful referral and the referring user's credibility rating improves.

### FIELD OF THE INVENTION

The present application relates generally to alerting users of Internet-enabled CE devices such as but not limited to TVs, digital radios, and game consoles when desired Internet content becomes available.

### BACKGROUND OF THE INVENTION

Internet access through TVs is typically provided by essentially programming the TV as though it were a computer executing a browser. Such Internet access is thus uncontrolled except as a firewall or filtering program might block certain sites.

As understood herein, uncontrolled Internet access may not be desirable in the context of a TV. A firewall or filtering program may not always be installed on the TV and even when one is installed, access remains much more uncontrolled than conventional TV programming traditionally has expected. Also, a locally installed filter can be unloaded or defeated by a user.

Accordingly, uncontrolled Internet access has several drawbacks. From a viewer's standpoint, exposure to inappropriate subject matter particularly when young viewers are watching is one concern; a much lower threshold of quality screening is another. That is, while many TV shows might not be widely considered as “quality” shows, nonetheless a TV program is usually much more selectively screened than, say, an Internet video. The expectations of TV viewers for such higher level quality screening as a consequence cannot be met by simply providing unfettered Internet access through the TV. Furthermore, TV-related entities, from content providers, manufacturers, and carriers, in most cases derive no benefit from the extension of TV to the Internet.

As understood herein, when an Internet Protocol-enabled TV (IPTV) requests Internet-sourced TV content, the IPTV may log in to an authentication server using the IPTV's device ID. This closely ties the client-server interaction very closely to the requesting IPTV, meaning that a user typically must access the desired Internet TV content using a pre-approved device.

### SUMMARY OF THE INVENTION

Accordingly and as also understood herein, it would be advantageous to allow a user to log in to an Internet TV server with certain authentication methods such as a unique username/password (or pin) combination, or via face/voice recognition technology, not necessarily tied to a particular device, by which the server can identify profile information of the user as indicated by the user-centric login. Per principles described further below, such a user-centric system allows users to login from any appropriate user device and establish/update their profile information, which can include a buddy list. Based on a privacy profile established by the user, the user may maintain the secrecy of his usage statistics, or permit his usage statistics to be made available only to buddies on the buddy list, or permit his usage statistics to be made available to all system users. This enables the server to publish information or recommend new content to other customers. For example, if user “John” is watching a TV episode and likes it, this can be followed by several options, e.g., “watch it now”, “get more details”, “find related content”, and “recommend your content to others.” The published information can be organized by the server based on one of the server criteria (e.g., the content theme such as romance, drama, action etc). Customers can follow the recommendations of other users and rate them based on the quality of the content. In addition, recommenders can get a share of the revenue generated based on their recommendations.

Accordingly, CE device has a housing, a display on the housing, an audio speaker, and a network interface. A processor controls the display and speaker and communicates with the Internet through the network interface. The processor establishes a user-centric account with an Internet Protocol TV (IPTV) system server and also establishes a privacy policy, by which an affiliated user affiliated with the account selects among plural options to publish comments entered by the user. At least two of the options are to publish only to users on a buddy list defined by the user and to publish to all system users subscribing to the affiliated user's comments.

The user-centric account may require a user name and password for log in. In some embodiments, a valid device ID must also be received by the server to enable log in to the account. In other embodiments, no device ID need be received by the server to permit log in to the account.

If desired, a privacy policy can be established by which the user indicates whether user viewing activity is to be provided to no other users, or to users only on the buddy list, or to every user, on the buddy list or not, participating in the IPTV system. The user can be enabled to subscribe to comments from other system users.

Various user interfaces (UI) are described. For example, a UI can be presented on the display listing plural privacy options, one of which is selectable by a user manipulating an input device to establish a privacy selection that is uploaded to the server. Also, a UI can be presented prompting a user to establish the buddy list. The buddy list can be built by importing users' contact lists from one or more of the user's email account, social networking website account, etc. Also, user can manually add buddies to the list by sending requests to other users. Further, a UI can be presented enabling the user to select, with a single click, the same privacy policy as is implemented for viewing activity. Still further, a UI can alert of reception of a comment from another user and present an option of selecting a program that is the subject of the comment. An entry element may be presented on the display into which a user receiving a comment can enter a rating indicating value of the comment which is uploaded to the server.

In another aspect, a server has a network interface and a processor communicating with the Internet through the network interface to provide an Internet Protocol TV (IPTV) program to a client device. The processor receives from the client device a user-desired privacy policy and user comments related to the IPTV program, publishing the comments in accordance with the privacy policy.

In another aspect, a method includes establishing user-centric authentication using a consumer electronics (CE) device with an Internet TV server which enables users to login to an Internet TV service from any enabled device. The method also includes using the server to recommend Internet TV content to other system users on a buddy list, and responsive to a buddy accepting an originating user's recommendation to view recommended content, receiving, at an account associated with the originating user, credit for remuneration.

The details of the present invention, both as to its structure and operation, can best be understood in reference to the accompanying drawings, in which like reference numerals refer to like parts, and in which:

### BRIEF DESCRIPTION OF THE DRAWINGS

FIG. 1 is a block diagram of an example system in accordance with present principles;

FIG. 2 is a block diagram of another example system in accordance with present principles;

FIG. 3 is a flow chart showing example user device logic;

FIG. 4 is a flow chart showing example server logic; and

FIGS. 5-9 are screen shots of user interfaces that can be presented on the user device to support present principles.

### DETAILED DESCRIPTION OF THE PREFERRED EMBODIMENT

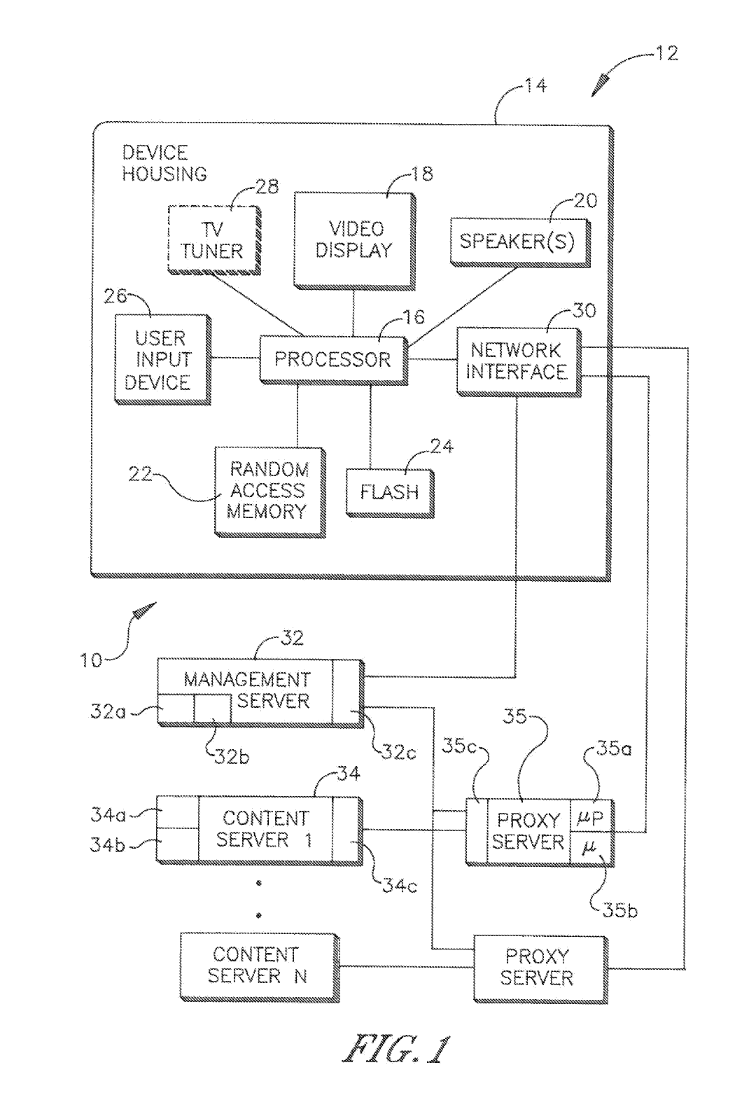

Referring initially to FIG. 1, an Internet Protocol TV (IPTV) system 10 includes an IPTV-enabled consumer electronics (CE) device 12 such as a TV, game player, video disk player, camera, digital clock radio, mobile telephone, personal digital assistant, laptop computer, etc. includes a portable lightweight plastic housing 14 bearing a digital processor 16. The processor 16 can control a visual display 18 and an audible display 20 such as one or more speakers.

To undertake present principles, the processor 16 may access one or more computer readable storage media such as but not limited to RAM-based storage 22 (e.g., a chip implementing dynamic random access memory (DRAM)) or flash memory 24. Software code implementing present logic executable by the CE device 12 may be stored on one of the memories shown to undertake present principles.

The processor 16 can receive user input signals from various input devices 26, including a remote control device, a point and click device such as a mouse, a keypad, etc. A TV tuner 28 may be provided in some implementations particularly when the CE device is embodied by a TV to receive TV signals from a source such as a set-top box, satellite receiver, cable head end, terrestrial TV signal antenna, etc. Signals from the tuner 28 are sent to the processor 16 for presentation on the display 18 and speakers 20.

As shown in FIG. 1, a network interface 30 such as a wired or wireless modem or wireless telephony transceiver communicates with the processor 16 to provide connectivity to a management server 32 on the Internet and to one or more content servers 34 which source Internet TV. If desired, each content server 34 may be associated with a respective proxy server 35 which interfaces the content server 34 with the device 12, it being understood that the proxy server may be consolidated within the content server 34 and a physically separate proxy server eliminated if desired. In any case, the servers 32, 34, 35 have respective processors 32a, 34a, 35a accessing respective non-transitory computer readable storage media 32b, 34b, 35b which may be, without limitation, disk-based and/or solid state storage. The servers communicate with a wide area network such as the Internet via respective network interfaces 32c, 34c, 35c. It is to be understood that the CE device 12 particularly when implemented by a non-PC device such as a TV or game console or camera can communicate only with the management server 32 and with content servers 34 that appear on a service list provided to the processor 16 by the management server 32, with the service list not being modifiable by the processor 16.

FIG. 2 shows a CE device 12a that in all essential respects is identical to the device 12 shown in FIG. 1, except that a network interface 30a is not located within the device housing 14a but instead is supported in a separate Internet link module housing 36 that may be mounted on the device housing 14a.

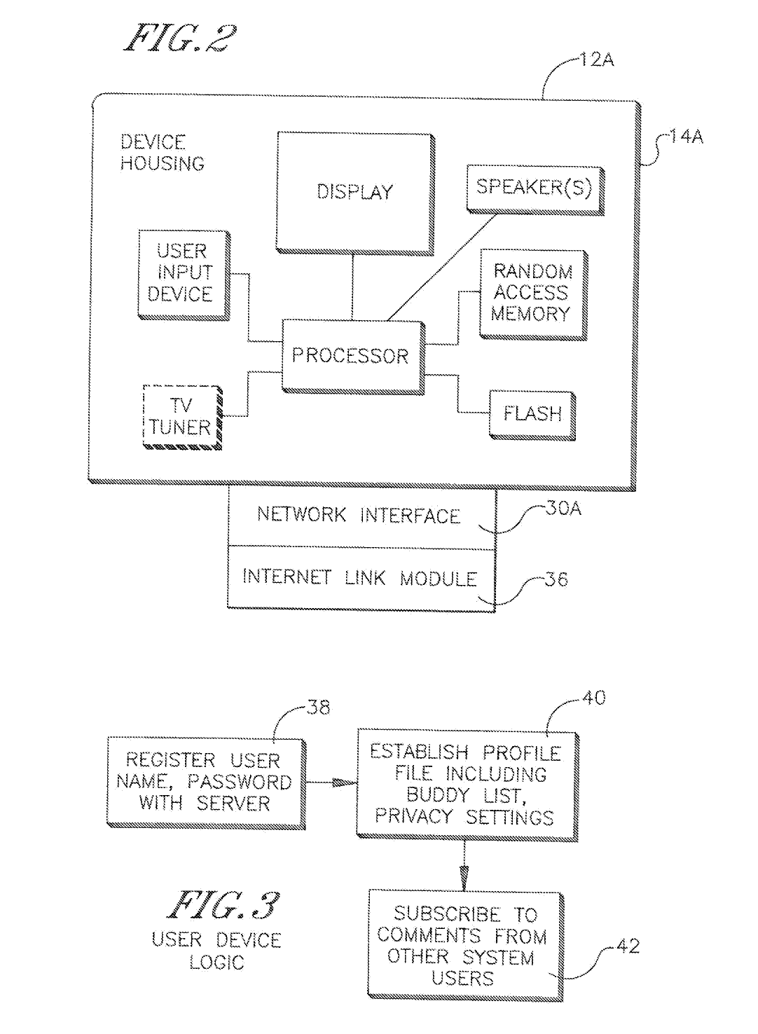

Now referring to FIG. 3, at block 38 a user of the CE device 12 creates an account with the management server 32 or associated content server 34/proxy server 35 by registering at least a user name and password and typically by also providing, if not already provided, personal accounting information such as credit card information. This user-centric registration may be in addition to or in lieu of device-centric registration described in co-pending U.S. patent application Ser. No. 12/782,174, filed May 18, 2010, incorporated herein by reference. In any case, with the user-centric registration a user can log in to the services provided by the servers 32/34/35 on any device and is not constrained to log in on the particular CE device 12 shown in FIG. 1 unless device-centric registration is also established.

Proceeding to block 40, the user, by means of a user interface (UI) or interfaces such as one or more of the example non-limiting UIs described below, establishes a profile that is associated by the server with the user name and password registered at block 38. The user profile can include privacy settings and a buddy list of other system users. The privacy settings may delineate to the server whether user viewing activity (e.g., channel/program presented on the CE device 12, duration of presentation, and time of day it of presentation) is to be provided to no other users, or to users only on the buddy list, or to every user, on the buddy list or not, participating in the Internet TV services provided by the servers. The privacy settings may also or alternatively delineate to the server whether user comments (described further below) that are input to the CE device 12 are to be provided to no other users, or to users only on the buddy list, or to every user, on the buddy list or not, participating in the Internet TV services provided by the servers. Thus, in some embodiments the user may establish a first privacy setting for viewing activity and a second, different privacy setting for comments.

Moving to block 42, the user can if desired subscribe to comments or contents published from other system users. For example, the user may elect to subscribe to comments from one or more users on the above-mentioned buddy list that the other users input into their respective Internet TV devices, conditioned on whatever privacy settings the other buddies may have established in accordance with present principles.

Example server logic may be seen in reference to FIG. 4. Commencing at block 44, as user comments are input to the CE device 12, which relays those comments to the server, and, if desired, as the user configures the device 12 to tune to particular broadcast TV or Internet TV channels to thereby establish viewing activity which is also reported by the device 12 to the server, the server records the comments and viewing activity. At block 46 the server establishes the privacy profile or profiles described above according to the user's commands and at block 48 the user's buddy selections of other users are received and recorded.

Block 50 indicates that the user who originates a suggestion to view programming that is accepted by other users is credited with cash, viewing credits, or other appropriate remuneration. Suppose, for example, that the user of the CE device 12 comments favorably on an Internet TV program, that comment is sent to all users on the user's buddy list in accordance with the user's privacy profile, and one of the buddies, within, say, a predetermined period of time accesses the program. The server can infer this activity to indicate that the buddy accessed the program in part because of the originating user's comments. In this case, the originating user's account would be credited with remuneration.

Note that the logic of FIG. 4 may be implemented by the management server 32, which can establish the privacy policy and buddy list for a particular user globally throughout the IPTV system, including causing the content servers 34/35 to implement the identical privacy policy and buddy list for a particular user. Or, the logic of FIG. 4 may be implemented by each content server 34/35 separately, meaning that a user may establish different buddy lists and different privacy policies from one content server to the next.

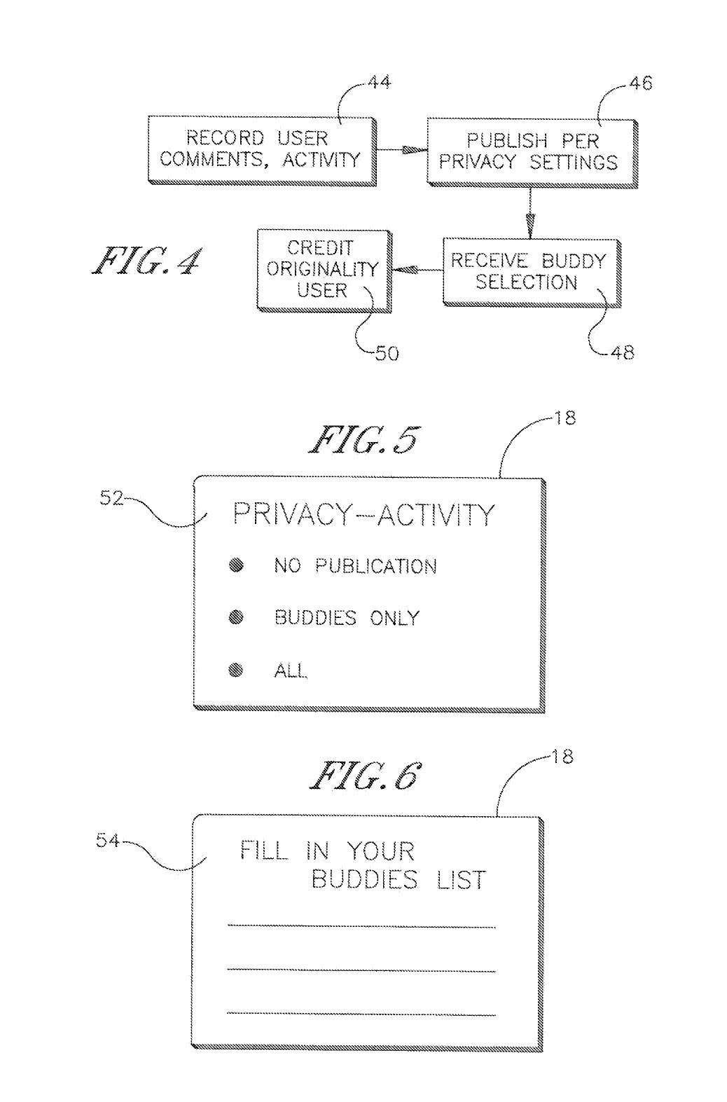

FIGS. 5-9 show UIs that further illustrate the above principles and set forth example non-limiting implementations to achieve them. In FIG. 5, a UI 52 is presented on the display 18 which lists the three privacy options mentioned above for activity publication, namely, “no publication”, publication only to users on the buddy list, or publication to everyone participating in the IPTV system. A user can manipulate an input device such as a wireless remote control (RC) to select one of the options, which selection is uploaded by the device 12 to the server 32/34/35 implementing the privacy policy.

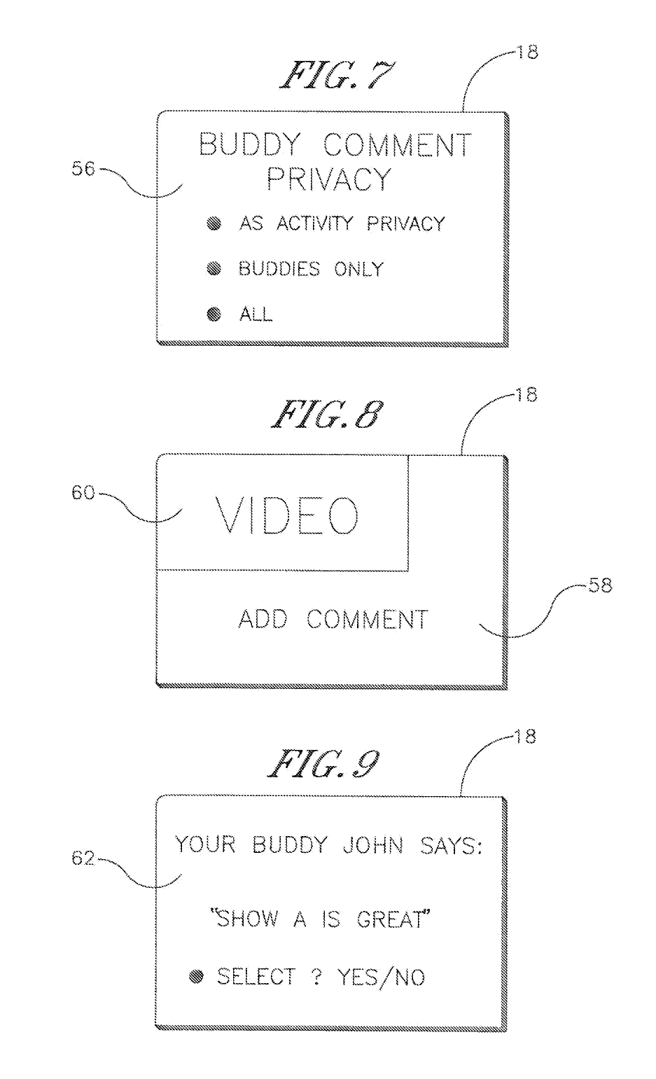

FIG. 6 shows that a UI 54 may be presented on the display 18 prompting a user to establish the above-described buddy list. As shown, the UI 54 contains fields into which the user, by means of an input device such as a RC, can enter the usernames of other IPTV system participants. The names are added by the CE device 12 to the buddy list of the user, which is uploaded to the server 32/34/35 implementing the logic. Then, a UI 56 as shown in FIG. 7 may be presented to permit the user to establish a privacy policy related to comments entered by the user into the CE device 12. In the embodiment shown, the UI 56 enables the user to select, with a single click; the same privacy policy as was implemented for viewing activity in FIG. 5 to be implemented for comments. The UI 56 also enables the user to select that only users on the buddy list are to be sent comments, or alternatively that all users in the IPTV system subscribing to view the particular user's comments may be sent the user's comments.

The UI 58 shown in FIG. 8 shows that those comments can be entered by a user by appropriately manipulating an input device while viewing broadcast TV or IPTV video in a video pane 60 on the display 18. The comments are uploaded from the CE device 12 to the appropriate server 32/34/35, where they are publicized in accordance with the privacy policy established using the UI 56 of FIG. 7. If desired, along with the comments a snapshot of the commenting user's viewing activity may be uploaded and published according to the privacy policy established with the UI 52 of FIG. 5. For example, the programs presented on the CE device 12 or other device into which the user logged in within the immediately past 24 hours may be uploaded and published.

FIG. 9 shows that when the user is receiving a comment from a buddy, a UI 62 can be presented on the display 18 alerting the user to this fact, repeating the buddy's comment and giving the user the option of selecting the particular program that was the subject of the comment. Should the receiving user select the particular program that was the subject of the comment by, e.g., clicking the “yes” option shown in FIG. 9, the commenting (originating) user can be credited with remuneration as explained at block 50 in FIG. 4.

If desired, the comments described above can be organized based on content theme (e.g., romantic, drama, action, etc.) That is, when published in accordance with the user-defined privacy policy, the comments may be grouped at recipient devices by content theme, and if desired a user of the IPTV system may thus subscribe not just to receive comments from other users but also to receive only comments pertaining to desired content themes. Additionally, if desired, in addition to selecting “yes” in FIG. 9 to tune receive the commented-upon program, a field may be provided into which the receiving user can enter a rating indicating how valuable they found the comment to be. The rating can be uploaded to the server and used in determining remuneration to be credited to the commenting user's account.

In addition to or in lieu of crediting a user's account with remuneration when a recipient user selects a recommended program, remuneration may be credited to a recommending user only if premium content requiring the recipient user to purchase it to view is selected. In any case, each user of the IPTV system can, by insightful comments and recommendations, build credibility amongst their buddies and/or comment subscribers so that the more popular a user's comments are, the more revenue the user may be credited with.

While the particular INTERNET TV CONTENT SHARING AND REVENUE GENERATION USING BUDDY LISTS AND SHORT MESSAGES is herein shown and described in detail, it is to be understood that the subject matter which is encompassed by the present invention is limited only by the claims.

What is claimed is:

1. CE device comprising:
housing;
display on the housing;
audio speaker;
network interface;
processor controlling the display and speaker and communicating with the Internet through the network interface;
the processor executing logic including:
establishing a user-centric account with an Internet Protocol TV (IPTV) system server; and
establishing a privacy policy by which an affiliated user affiliated with the account selects among plural options to publish comments entered by the user, at least two of the options being to publish only to users on a buddy list defined by the user and to publish to all system users subscribing to the affiliated user's comments.

2. The CE device of claim 1, wherein the user-centric account requires a user name and password for log in.

3. The CE device of claim 2, wherein a valid device ID must also be received by the server to enable log in to the account.

4. The CE device of claim 2, wherein no device ID need be received by the server to permit log in to the account.

5. The CE device of claim 1, wherein the processor further executes logic comprising:
establishing a privacy policy by which the user indicates whether user viewing activity is to be provided to no other users, or to users only on the buddy list, or to every user, on the buddy list or not, participating in the IPTV system.

6. The CE device of claim 1, wherein the processor further executes logic comprising enabling the user to subscribe to comments from other system users.

7. The CE device of claim 1, wherein the processor further executes logic comprising presenting a user interface (UI) on the display listing plural privacy options, one of which is selectable by a user manipulating an input device to establish a privacy selection, the privacy selection being uploaded to the server.

8. The CE device of claim 1, wherein the processor further executes logic comprising presenting a user interface (UI) on the display prompting a user to establish the buddy list.

9. The CE device of claim 8, wherein the processor further executes logic comprising presenting a user interface (UI) on the display, the UI enabling the user to select, with a single click, the same privacy policy as is implemented for viewing activity.

10. The CE device of claim 1, wherein the processor further executes logic comprising presenting a user interface (UI) on the display alerting reception of a comment from another user and presenting an option of selecting a program that is the subject of the comment.

11. The CE device of claim 10, wherein the processor presents on the display a entry element into which a user receiving a comment can enter a rating indicating value of the comment, the rating being uploaded to the server.

12. Server comprising:
network interface;
processor communicating with the Internet through the network interface;
the processor executing logic including:
providing an Internet Protocol TV (IPTV) program to a client device;
receiving from the client device a user-desired privacy policy;
receiving from the client device user comments related to the IPTV program; and
publishing the comments in accordance with the privacy policy.

13. The server of claim 12, wherein the processor further executes logic comprising:
sending to the client device comments of other users depending on a subscription selected by the user of the client device.

14. The server of claim 12, wherein the processor further executes logic comprising:
responsive to an originating user suggestion to view programming being accepted by a recipient user, crediting an account affiliated with the originating user with remuneration.

15. The server of claim 12, wherein the server is a first server communicating with plural IPTV system servers, and the privacy policy is implemented by all of the servers.

16. The server of claim 12, wherein the server is a first server communicating with plural IPTV system servers, each server communicating with the client device and receiving a respective privacy policy therefrom such that at least two servers implement two respective privacy policies that are different from each other.

17. Method comprising:
establishing user-centric authentication using a consumer electronics (CE) device with an Internet TV server which enables users to login to an Internet TV service from any enabled device;
using the server, recommending Internet TV content to other system users on a buddy list; and
responsive to a buddy accepting an originating user's recommendation to view recommended content, receiving, at an account associated with the originating user, credit for remuneration.

18. The method of claim 17, comprising:
establishing a privacy policy by which the user affiliated with the account establishes among plural options to publish comments entered by the user, at least two of the options being to publish only to users on the buddy list and to publish to all system users subscribing to the originating user's comments.

19. The method of claim 17, wherein the user-centric authentication requires a user name and password for log in.

20. The method of claim 17, comprising establishing a privacy policy by which the user indicates whether user viewing activity is to be provided to no other users, or to users only on the buddy list, or to every user, on the buddy list or not, participating in an IPTV system.
